(19) United States
(12) Patent Application Publication
(10) Pub. No.: US 2004/0073628 A1
(43) Pub. Date: Apr. 15, 2004

(54) Medical image photographing management terminal and medical image photographing system

(75) Inventor: Tetsuya Usui, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/660,494

(22) Filed: Sep. 12, 2003

(30) Foreign Application Priority Data
Sep. 20, 2002 (JP) 2002-274224

(51) Int. Cl. G06F 15/16

(52) U.S. Cl. 709/217

(57) ABSTRACT

A medical image photographing management terminal in which, in the case where each photo studio is furnished with a medical image photographing management terminal without constituting a large-scale system and even in the case where after ID information has been registered in one photo studio and the patient moves to another photo studio, the ID information can be used in the another photo studio. The medical image photographing management terminal includes an input unit to be used for inputting ID information, a storage unit for storing information, and a control unit for controlling writing of the ID information into the storage unit and reading of the ID information from the storage unit, and permitting reference and editing of the ID information from another medical image photographing management terminal in response to a request from the another medical image photographing management terminal.

### BACKGROUND OF THE INVENTION

1. Field of the Invention

The present invention relates to a medical image photographing management terminal to be used for managing photographing for the purpose of diagnosis such as radiation photographing, and to a medical image photographing system including such medical image photographing management terminal.

2. Description of a Related Art

Conventionally, photographing method that uses radiation (X-ray, alpha ray, beta ray, gamma ray, electron ray, ultraviolet ray or the like) has been utilized in a variety of fields. Particularly, in medical field, the method is one of the most important techniques for diagnosis. Since the first X-ray photography was achieved, a number of improvements on the X-ray photography have been piled up and presently, a method, in which a fluorescent screen and an X-ray film are combined with each other, prevails. On the other hand, recently, a variety of digitalized apparatus such as X-ray CT, ultrasonic and MRI have been put to practical use, and a diagnosis information processing system or the like is going to be built in a hospital. Also as to the X-ray photography, a lot of studies for digitalization thereof have been made. A radiation photographing method using photostimulable phosphor has been established, and attracts attention as a method that will supersede the conventional X-ray photography.

The photostimulable phosphor (cumulative fluorescent material) is a material that, when it is irradiated with radiation, it accumulates a part of the radiation energy, and after that, when it is irradiated with excitation light such as visible light, it emits photostimulated light corresponding to the accumulated energy, and the existence of the above material is conventionally known. The radiation photographing method by using the photostimulable phosphor is as described below. That is, radiation image such an object of a human body or the like is photographed and recorded on a sheet (recording sheet) applied with photostimulable phosphor. When the recording sheet is scanned with excitation light such as laser beam, photostimulated light is emitted. By reading the light in a photoelectric manner, image data can be obtained. After appropriately processing the image data, the radiation image can be displayed as a visible image by outputting it on a display such as a CRT or printing it on a film by using a laser printer or the like.

The above-described radiation photographing method has performance comparable with conventional X-ray photography in aspects of photosensitivity and image quality. For example, compared with the conventional X-ray photographing method, exposure range is extremely wider, and the response of the photostimulated light to the exposure amount is substantially proportional all over the exposure range. Even when the object is photographed with any amount of radiation, it is possible to capture light emission area in which the image resides, and to normalize into digital signals in just proportions. Further, by combining the signals obtained as described above with an appropriate image processing method, it is possible to stably provide images with satisfactory quality under various photographing conditions. Furthermore, since digitalized image information is obtained directly, it is possible not only to conserve large-scale data for long period of time without allowing any deterioration of image but also to develop the radiation photographing method to a medical diagnosis information system or the like.

When a radiation photographing of an object is made by using a medical image photographing apparatus, registration of ID information is made which includes object information such as sex and name of the patient as the object and photographing information such as date of the photograph and photographed portion. For the above purpose, ordinarily an ID terminal (medical image photographing management terminal) is provided in the vicinity of the medical image photographing apparatus in order to register the ID information, and the ID information is registered in the ID terminal by loading a magnetic card in which necessary information has been previously recorded or by carrying out input operation manually.

Also, in a recording sheet, ordinarily a bar code is indicated as an identification mark to distinguish a recording sheet from other recording sheets. In addition to the registration of the ID information, the ID terminal reads out the bar code as well and stores the ID information and the bar code into storage means such as a memory, a hard disk or the like while coupling them with each other.

Further, in the vicinity of the medical image photographing apparatus, ordinarily a medical image reader is also provided. In the medical image photographing apparatus, the recording sheet in which the radiation image is recorded is loaded onto the medical image reader, and the bar code and image information are read out. The read out bar code is sent to the above-mentioned storage means and the ID information corresponding to the bar code is read out. The read out ID information is sent to the medical image reader and the medical image processing apparatus and is used for setting of read-out conditions and carrying out image processing, and is displayed as a visible image along with the radiation image.

Here, when a system which includes a plurality of ID terminals and a plurality of medical image readers is constituted, central management of the ID information is made possible when an information management apparatus is provided which is capable of storing information input to a plurality of ID terminals as a batch and retrieving the stored information at anytime. Contrary to that, there arises such problem that, when the information management apparatus fails, the entire system becomes beyond the management.

In order to solve the above-described problem, Japanese Unexamined Patent Application Publication JP-A-4-123173 (page 1-2, FIG. 1) discloses a radiation image information processing system in which a plurality of registration means (ID terminal) with an information management function are connected to each of a plurality of medical image readers and information can be exchanged among these registration means, thereby decentralized administration of the ID information is achieved.

However, according to the above-described radiation image information processing system, ID information input to an ID terminal can be referred to or edited by the ID terminal only. Ordinarily, each photo studio is provided with one ID terminal. Accordingly, after a piece of ID information has been registered in a photo studio, in the case where the photographing apparatus has to be changed in accordance with a photographing technique or it is necessary to move to another photo studio due to a failure of the photographing apparatus, it is inconvenient since the ID information can not be used by any ID terminal other than the terminal to which the ID information is registered.

On the other hand, in order to manage various services concerning the photographing of the radiation image, there may be a case where a large-scale medical image photographing system including a radiology information system (RIS) is used. For example, in addition to the registration of the ID information, the RIS is used to manage the services of reception, order input, display of waiting patients, input of photographing record, connection of photographing equipments, status reference of each photo studio and so on. In such large-scale medical image photographing system, it is possible to access to the identical ID information from ID terminals provided in a plurality of photo studios.

However, also in such a large-scale medical image photographing system, it is impossible to obtain detailed information such as to which radiation image has been photographed in a series of inspections of a patient.

### SUMMARY OF THE INVENTION

The present invention has been achieved in view of the above-described problems. An object of the present invention is to provide a medical image photographing management terminal and a medical image photographing system in which, in the case where each of the photo studios is furnished with the medical image photographing management terminal to be used in photographing medical images without constituting a large-scale system including a radiation image information management system (RIS) and even in the case where after ID information has been registered in one photo studio and the patient moves to another photo studio, the ID information can be used in the another photo studio.

To solve the above-described problems, a medical image photographing management terminal according to a first aspect of the present invention comprises input means to be used for, when carrying out photographing for a purpose of diagnosis, inputting ID information including information about a patient as an object or information about the photographing; storage means for storing information; and control means for controlling writing of the ID information inputted by using the input means into the storage means and reading of the ID information from the storage means, and permitting the ID information stored in the storage means to be referred to or edited from another medical image photographing management terminal in response to a request from the another medical image photographing management terminal.

Further, a medical image photographing management terminal according to a second aspect of the present invention comprises input means to be used, when carrying out photographing for a purpose of diagnosis, for inputting ID information including information about a patient as an object or information about the photographing; storage means for storing information; and control means for controlling writing of the ID information inputted by using the input means into the storage means and reading of the ID information from the storage means, and transmitting the ID information stored in the storage means to another medical image photographing management terminal and deleting the ID information stored in the storage means in response to a request from the another medical image photographing management terminal.

Still further, a medical image photographing system according to the present invention in which photographing is carried out for a purpose of diagnosis on the basis of ID information including information about a patient as an object or information about the photographing, comprises a plurality of medical image photographing apparatuses to be used for carrying out the photographing for the purpose of diagnosis; and a plurality of medical image photographing management terminals including a first medical image photographing management terminal corresponding to a first medical image photographing apparatus and a second medical image photographing management terminal corresponding to a second medical image photographing apparatus, each of the plurality of medical image photographing management terminals including control means for permitting the ID information managed by the first medical image photographing management terminal to be used in the second medical image photographing management terminal when the photographing is carried out by using the second medical image photographing apparatus and the second medical image photographing management terminal on the basis of the ID information inputted by using the first medical image photographing management terminal.

According to the present invention, since such control means is provided that makes it possible to use ID information stored in a medical image photographing management terminal from another medical image photographing management terminal, in the case where each of the photo studios is furnished with the medical image photographing management terminal to be used in photographing medical images without constituting a large-scale system including a radiation image information management system (RIS) and even in the case where after ID information has been registered in one photo studio and the patient moves to another photo studio, the ID information can be used in the another photo studio.

### BRIEF DESCRIPTION OF THE DRAWINGS

FIG. 1 is a block diagram showing a constitution of a medical image photographing system according to an embodiment of the present invention; and

FIG. 2 is a block diagram showing a constitution of a medical image photographing management terminal as shown in FIG. 1.

### DESCRIPTION OF THE PREFERRED EMBODIMENTS

Now, referring to the drawings, embodiments of the present invention will be described.

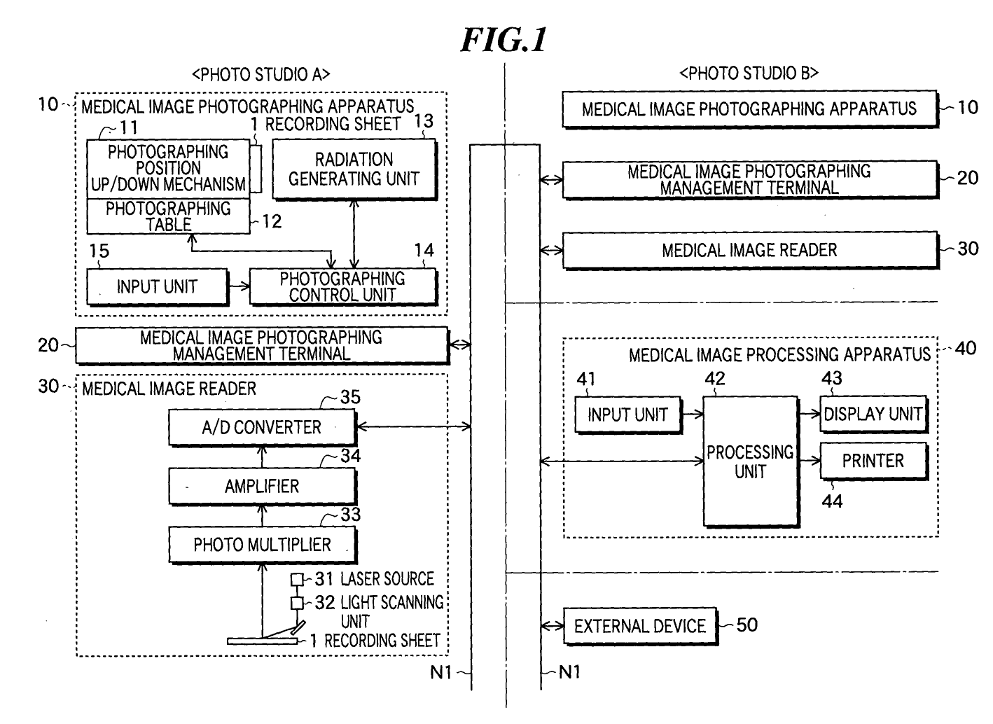

FIG. 1 is a block diagram showing a constitution of a medical image photographing system according to an embodiment of the present invention. As shown in FIG. 1, the medical image photographing system comprises a set of a medical image photographing apparatus 10, a medical image photographing management terminal 20 and a medical image reader 30, which are furnished in each of a plurality of photo studios A and B, and a medical image processing apparatus 40, which is furnished in a photo studio or another room. These are connected to each other through a network Nl. Also, if necessary, an external device 50 such as a database sever, an ID card reader, a terminal unit or the like of a medical center may be connected to the network Nl.

The medical image photographing apparatus 10 performs photographing by irradiating radiation onto an object, thereby, records a radiation image on a recording sheet (photostimulable phosphor sheet) 1. As shown in FIG. 1, the medical image photographing apparatus 10 includes a photographing position up/down mechanism 11 that moves up/down the position of the recording sheet 1, thereby, to shift the position to be photographed on the object, a photographing table 12 that positions the feet of a patient as an object, a radiation generating unit 13 that irradiates the radiation onto the object, a photographing control unit 14 that controls the radiation generating unit 13, etc. in accordance with given photographing conditions, and an input unit 15 to be used for inputting various commands, photographing conditions and so on.

When a radiation photographing of an object is made by using the medical image photographing apparatus 10, registration of ID information is made including object information such as sex, name and so on of the patient as the object and photographing information such as date of the photograph, photographed portion and so on. For the above purpose, in the vicinity of the medical image photographing apparatus 10, the medical image photographing management terminal 20 to be used for registering the ID information and managing the radiation photographing is placed. In the recording sheet, ordinarily, a bar code is indicated as an identification mark to distinguish one recording sheet from other recording sheets. In addition to the registration of the ID information, the medical image photographing management terminal 20 reads out the bar code as well and stores the ID information and the bar code into storage means such as a memory, a hard disk or the like while coupling them with each other. The constitution and operation of the medical image photographing management terminal 20 will be described in detail afterward.

The recording sheet 1 as a recording medium to be used for the radiation photographing is applied with a photostimulable phosphor material, and records information of the object by being irradiated with the radiation. Under predetermined photographing conditions, a radiation photographing of the object is made and the radiation image thereof is recorded on the recording sheet 1. Information relevant to the image representing attributes of the radiation image is also recorded on the recording sheet 1. After photographing, the recording sheet 1 is set on a predetermined position of the medical image reader 30.

The medical image reader 30 reads out the information of the radiation image and so on recorded in the recording sheet 1 in a photoelectric manner and generates image data and information relevant to the image. As shown in FIG. 1, in the medical image reader 30, the optical beam emitted from a laser source 31 goes through a light-scanning unit 32 to scan the surface of the recording sheet 1. Owing to the above scanning, the optical beam is irradiated onto the recording sheet 1, from the portion where is irradiated with the optical beam, photostimulable emission of a light intensity corresponding to the accumulated and recorded information of the radiation image is generated. The photostimulable emission is detected by a photo multiplier 33 in a photoelectric manner, and a detection signal is outputted as an analogue signal, amplified by an amplifier 34 and digitalized by an A/D converter 35.

At that time, the bar code indicated on the recording sheet 1 is also read out. The read out bar code is sent to storing means of the medical image photographing management terminal 20 and ID information corresponding to the bar code is readout. The readout ID information is sent to the medical image reader 30 and the medical image processing apparatus 40 and is used for setting of read-out conditions and carrying out image processing, and is displayed as a visible image along with the radiation image. The image data and the information relevant to the image generated by the medical image reader 30 is input to the medical image processing apparatus 40 via the network Nl.

The medical image processing apparatus 40 includes an input unit 41 that is used for inputting various commands and information for operating the medical image photographing system, a processing unit 42 that performs image processing on the image data such as normalization, tone processing and logic read processing, a display unit 43 that displays medical diagnosis images on the basis of the image data on which image processing has been made and a printer 44 that prints out the medical diagnosis image on a film or the like. The medical image processing apparatus 40 inputs the image data and the information relevant to the image from the medical image reader 30 and performs various processing and displays or outputs medical diagnosis images.

Next, the medical image photographing management terminal will be explained in detail.

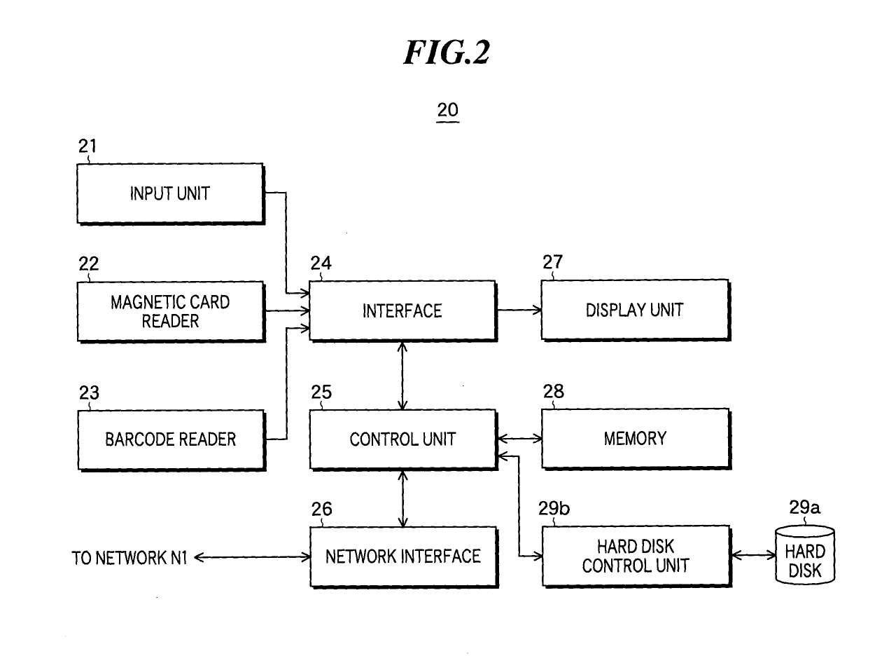

FIG. 2 is a block diagram showing a constitution of the medical image photographing management terminal shown in FIG. 1. In the medical image photographing management terminal 20, as input means for inputting ID information including information about the patient as the object or information about the photographing when carrying out photographing for a purpose of diagnosis, there are provided an input unit 21 such as keyboard, mouse or the like for an operator to carry out input operation, and a magnetic card reader 22 that reads out ID information from a magnetic card in which the ID information has been previously recorded. Further, in order to read the bar code indicated on the recording sheet as the identification mark, a bar code reader 23 is provided. The input unit 21, the magnetic card reader 22 and the bar code reader 23 are connected to a control unit 25 via an interface 24. A network interface 26 is used for connecting the medical image photographing management terminal 20 to the network Nl.

Further, in the medical image photographing management terminal 20, there are provided a display unit 27 for displaying the ID information, photographing menu or the like, a memory 28, a hard disk 29a and a hard disk control unit 29b as storage means for storing the ID information, bar code, program and so on. The control unit 25 comprises a CPU and software (program), and controls writing of the ID information inputted by using the input means into the storage means and reading of the ID information from the storage means. Under the control of the control unit 25 as described above, the ID information is registered.

Next, the operation of the medical image photographing management terminal shown in FIG. 2 will be described.

After registering ID information by using the medical image photographing management terminal 20 provided in a photo studio A, an operator carries out photographing of radiation image of a patient by using the medical image photographing apparatus 10 furnished in the photo studio A. After completing a part of the photographing, in the case where the medical image photographing apparatus 10 has to be changed in accordance with photographing technique, or in the case where the medical image photographing apparatus 10 has failed, the operator interrupts the photographing in the photo studio A and moves to a photo studio B along with the patient.

By using the medical image photographing management terminal 20 furnished in the photo studio B, the operator carries out operation to refer to or edit the ID information registered in the medical image photographing management terminal 20 furnished in the photo studio A. The control unit 25 of the medical image photographing management terminal 20 furnished in the photo studio B transmits the request for referring to or editing of the relevant ID information to the medical image photographing management terminal 20 furnished in the photo studio A. Corresponding to the request, the control unit 25 of the medical image photographing management terminal 20 furnished in the photo studio A permits the reference or editing of the relevant ID information from the medical image photographing management terminal 20 furnished in the photo studio B. Owing to this arrangement, the operator can continue the photographing of radiation image of the patient by using the medical image photographing apparatus 10 furnished in the photo studio B.

As for a series of the photographing carried out by using the medical image photographing management terminal 20 furnished in the photo studio B, it is preferred that the control unit 25 of the medical image photographing management terminal 20 prohibits reference or editing of the relevant ID information from another medical image photographing management terminal. Owing to this arrangement, it is possible to prevent overlapped identical photographing from being carried out by a plurality of medical image photographing management terminals, and further prevent inconsistency on the data due to simultaneous access from occurring.

Alternatively, in the case where the operator interrupts the photographing in the photo studio A and moves to the photo studio B, the following operation may be carried out. By using the medical image photographing management terminal 20 furnished in the photo studio B, the operator carries out an operation to transfer the ID information registered in the medical image photographing management terminal 20 furnished in the photo studio A to the medical image photographing management terminal 20 furnished in the photo studio B. The control unit 25 of the medical image photographing management terminal 20 furnished in the photo studio B transmits a request for the relevant ID information to the medical image photographing management terminal 20 furnished in the photo studio A. Responding to the request, the control unit 25 of the medical image photographing management terminal 20 furnished in the photo studio A transmits the relevant ID information to the medical image photographing management terminal 20 furnished in the photo studio B, and deletes the ID information stored in its own storage means. Owing to this arrangement, the operator can continue the photographing of radiation image of the patient by using the medical image photographing apparatus 10 furnished in the photo studio B.

Owing to the above operation, since it is impossible to access the data simultaneously from a plurality of medical image photographing management terminals, it is possible to prevent overlapped identical photographing from being carried out from the plurality of medical image photographing management terminals, and further prevent inconsistency on the data due to simultaneous access from occurring.

In addition to the medical image photographing management terminal furnished in the photo studio, a dedicated medical image photographing management terminal for registering the ID information may be provided. In this case, the photographing can be carried out by referring the ID information, which has been registered by using the dedicated medical image photographing management terminal for registering the ID information, by using the medical image photographing management terminal furnished in the photo studio.

Further, it may be arrange so that, in a medical image display unit which is used by a person in charge such as an engineer for quality assurance (QA) of photographed medical images, data may be mutually utilized among a plurality of terminals in the same manner as described above. In such a case, by preparing a dedicated terminal for QA, it is possible to flexibly cope with a central quality assurance service by an authorized senior engineer or the like.

Furthermore, when it is arranged so that the status such as “PHOTOGRAPHING” or “IN QA” is indicated or allowed to make reference in a waiting room and so on, it is convenient for patients waiting their turn in the waiting room and so on.

As described above, according to the present invention, in the case where each of the photo studios is furnished with the medical image photographing management terminal to be used in photographing medical images without constituting a large-scale system including a radiation image information management system (RIS) and even in the case where after ID information has been registered in one photo studio and the patient moves to another photo studio, the ID information can be used in the another photo studio.

1. A medical image photographing management terminal comprising:
input means to be used, when carrying out photographing for a purpose of diagnosis, for inputting ID information including at least one of information about a patient as an object and information about the photographing;
storage means for storing information; and
control means for controlling writing of the ID information inputted by using said input means into said storage means and reading of the ID information from said storage means, and permitting the ID information stored in said storage means to be referred to or edited from another medical image photographing management terminal in response to a request from the another medical image photographing management terminal.

2. The medical image photographing management terminal according to claim 1, wherein said control means prohibits reference or editing of the ID information from another medical image photographing management terminal with respect to a series of photographing being carried out by using the medical image photographing management terminal.

3. A medical image photographing management terminal comprising:
input means to be used, when carrying out photographing for a purpose of diagnosis, for inputting ID information including at least one of information about a patient as an object and information about the photographing;
storage means for storing information; and
control means for controlling writing of the ID information inputted by using said input means into said storage means and reading of the ID information from said storage means, and transmitting the ID information stored in said storage means to another medical image photographing management terminal and deleting the ID information stored in said storage means in response to a request from the another medical image photographing management terminal.

4. A medical image photographing system in which photographing is carried out for a purpose of diagnosis on the basis of ID information including at least one of information about a patient as an object and information about the photographing, said system comprising:
a plurality of medical image photographing apparatuses to be used for carrying out the photographing for the purpose of diagnosis; and
a plurality of medical image photographing management terminals including a first medical image photographing management terminal corresponding to a first medical image photographing apparatus and a second medical image photographing management terminal corresponding to a second medical image photographing apparatus, each of said plurality of medical image photographing management terminals including control means for permitting the ID information managed by said first medical image photographing management terminal to be used in said second medical image photographing management terminal in a case where the photographing is carried out by using said second medical image photographing apparatus and said second medical image photographing management terminal on the basis of the ID information inputted by using said first medical image photographing management terminal.

5. The medical image photographing system according to claim 4, wherein:
said second medical image photographing management terminal transmits to said first medical image photographing management terminal a request for reference or editing of the ID information managed by said first medical image photographing management terminal; and
said first medical image photographing management terminal permits the ID information stored in storage means of said first medical image photographing management terminal to be referred to or edited from said second medical image photographing management terminal in response to the request from said second medical image photographing apparatus.

6. The medical image photographing system according to claim 4, wherein:
said second medical image photographing management terminal transmits to said first medical image photographing management terminal a request for the ID information managed by said first medical image photographing management terminal; and
said first medical image photographing management terminal transmits the ID information stored in storage means of said first medical image photographing management terminal to said second medical image photographing management terminal and deletes the ID information stored in said storage means in response to the request from said second medical image photographing management terminal.
